(19) United States
(12) Patent Application Publication
(10) Pub. No.: US 2019/0179280 A1
(43) Pub. Date: Jun. 13, 2019

(54) Method For Initializing An Appliance In A Delivery State And Appliance

(71) Applicant: FRIWO Geratebau GmbH, Ostbevern (DE)

(72) Inventor: Victor Heine, Munster (DE)

(73) Assignee: FRIWO Geratebau GmbH, Ostbevern (DE)

(21) Appl. No.: 16/213,488

(22) Filed: Dec. 7, 2018

(30) Foreign Application Priority Data
Dec. 7, 2017 (EP) 17 205 855.4

(51) Int. Cl. G05B 19/042; H05B 37/02; H02J 13/00

(52) U.S. Cl. CPC G05B 19/0426; G05B 2219/25252; H02J 13/00; H05B 37/0209

(57) ABSTRACT

A method for initializing an appliance in a delivery state comprises providing a control unit connected to a memory unit and a variable control mechanism, storing a first code word in the memory unit, and changing the first code word to a second code word using the control unit when the variable control mechanism is adjusted by a user. The variable control mechanism is adjustable by the user to control an output value of the appliance. A predetermined delivery output value of the appliance is associated with the first code word.

### CROSS-REFERENCE TO RELATED APPLICATION

This application claims the benefit of the filing date under 35 U.S.C. § 119(a)-(d) of European Patent Application No. 17205855.4, filed on Dec. 7, 2017.

### FIELD OF THE INVENTION

The present invention relates to an appliance and, more particularly, to a method for initializing an appliance in a delivery state.

### BACKGROUND

An appliance, for example a power supply or a light source, can supply an adjustable output value, such as an output voltage, an output current, a light color, or a light intensity. An appliance with such a variable output has a variable control mechanism that is user adjustable for controlling the adjustable output value. A user adjusts a user adjusting element, for example a tap changer, a control knob, an actuator, or the like, connected to the variable control mechanism for controlling the output value.

A manufacturer of the appliance delivers the appliance in a delivery state. The appliance operates as delivered until the user adjusts the variable control mechanism; the delivery state of the appliance is different from a state of the appliance after the user initially adjusts the variable control mechanism. For example, the appliance outputs a delivery output value until the user adjusts the variable control mechanism to have the appliance output a different output value.

The manufacturer determines whether the appliance is in the delivery state or not in order to check parameters of the appliance for quality assurance. If the appliance is in the delivery state, the output value is the delivery output value. Each appliance in a series is delivered with the same delivery output value, and a uniform output value improves quality control for the manufacturer and simplify commissioning procedures for the user. Each appliance in a series is currently adjusted manually to deliver the appliance with the delivery output value. However, there is a need for the appliance to provide a predetermined output value after unpacking to be adapted for plug and play start-up by the user without adjusting the output value.

### SUMMARY

A method for initializing an appliance in a delivery state comprises providing a control unit connected to a memory unit and a variable control mechanism, storing a first code word in the memory unit, and changing the first code word to a second code word using the control unit when the variable control mechanism is adjusted by a user. The variable control mechanism is adjustable by the user to control an output value of the appliance. A predetermined delivery output value of the appliance is associated with the first code word.

### BRIEF DESCRIPTION OF THE DRAWINGS

The invention will now be described by way of example with reference to the accompanying Figures, of which:

FIG. 1 is a schematic diagram of an appliance according to an embodiment;

FIG. 2 is another schematic diagram of the appliance;

FIG. 3 is a flow chart depicting a process for preparing the appliance;

FIG. 4 is a flow chart depicting a process for operating the appliance according to an embodiment; and

FIG. 5 is a flow chart depicting a process for operating the appliance according to another embodiment.

### DETAILED DESCRIPTION OF THE EMBODIMENT(S)

Embodiments of the present invention will be described hereinafter in detail with reference to the attached drawings, wherein like reference numerals refer to the like elements. The present invention may, however, be embodied in many different forms and should not be construed as being limited to the embodiments set forth herein; rather, these embodiments are provided so that the disclosure will be thorough and complete and will fully convey the concept of the invention to those skilled in the art. Furthermore, several aspects of the embodiments may form-individually or in different combinations-solutions according to the present invention. The following described embodiments thus can be considered either alone or in any combination thereof.

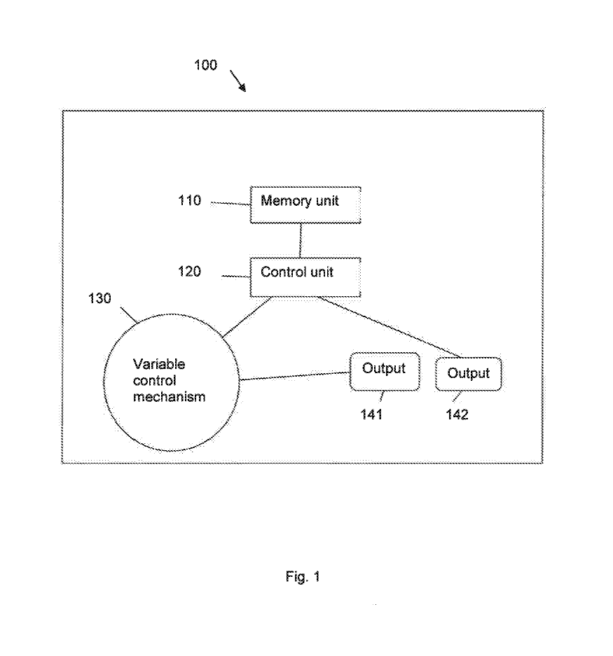

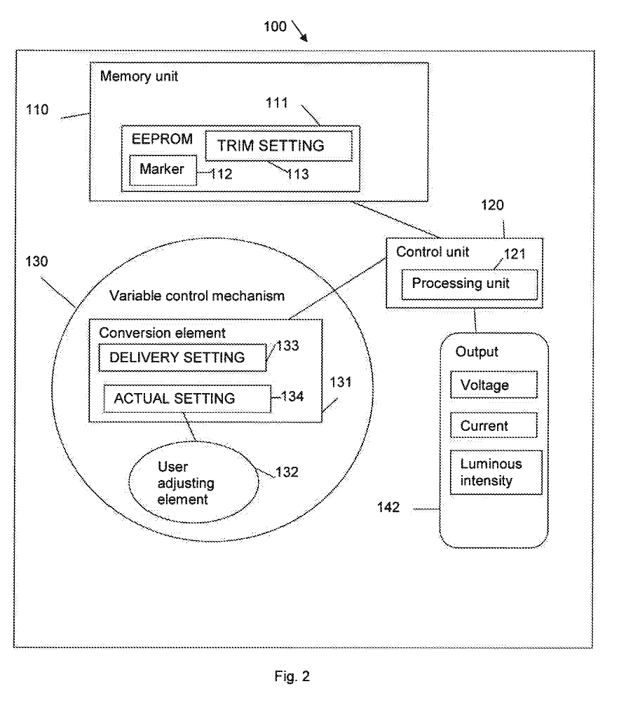

An appliance 100 according to an embodiment is shown in FIGS. 1 and 2. The appliance 100 comprises a memory unit 110, a control unit 120, a variable control mechanism 130, a first output 141, and a second output 142.

As shown in FIG. 1, the variable control mechanism 130 is connected to the control unit 120 and to the first output 141. The control unit 120 is connected to the memory unit 110 and to the second output 142. In another embodiment, the first output 141 can include a plurality of first outputs 141 and the second output 142 can include a plurality of second outputs 142.

The memory unit 110, shown in FIGS. 1 and 2, is a non-transitory computer readable medium adapted for storing data. In the embodiment shown in FIG. 2, the memory unit 110 includes an electrically erasable programmable read-only memory (EEPROM) 111. In another embodiment, the memory unit 110 may include other non-transitory computer-readable mediums, for example, a random-access memory (ROM). The stored data may be any sequence of bits and can include delivery settings of the appliance 100, delivery settings of the control unit 120, and/or delivery settings of the variable control mechanism 130. The memory unit 110 also stores a delivery output value that can be output at the second output 142. Data can be stored in the memory unit 110 via the control unit 120, can be stored in advance in the memory unit 110, or can be stored in the memory unit 110 by a memory storing unit.

The control unit 120, shown in FIGS. 1 and 2, can retrieve data from the memory unit 110, can store data in the memory unit 110, and can change data in the memory unit 110. The control unit 120 can retrieve data from the variable control mechanism 130 and send data to the second output 142. In an embodiment, the control unit 120 can sense an adjusted value adjusted at the variable control mechanism 130 and can calculate an output value for the second output 142 based on the sensed adjusted value adjusted at the variable control mechanism 130. As shown in FIG. 2, the control unit 120 includes a processing unit 121, such as a microprocessor, adapted to execute program instructions stored on the memory unit 110 to control the appliance 100 as described herein.

The variable control mechanism 130, shown in FIGS. 1 and 2, can be adjusted by a user for controlling the output value of the first output 141 or the second output 142. The variable control mechanism 130, as shown in FIG. 2, includes a user adjusting element 132 and a conversion element 131. The user adjusting element 132 is a switching element and, in various embodiments, may be a tap changer, a control knob, an actuator, or the like. A user can adjust the user adjusting element 132 by applying, for example, a mechanical force, an electrical force, a magnetic force, or the like. The user adjusting element 132 is connected to the conversion element 131.

The conversion element 131, shown in FIG. 2, converts an actual setting 134 of the user adjusting element 132 to an adjusted value, which can be sensed and processed by the control unit 120. The conversion element 131 is connected to the control unit 120 and can also directly output the adjusted value at the first output 141. In an embodiment, the conversion element 131 is a potentiometer, which can supply a voltage depending on the actual setting 134 to the control unit 120. The conversion element 131 can provide a delivery setting 133, which is calculated based on predetermined values of the conversion element 131. Predetermined values of the conversion element 131 are, for example, a minimum and a maximum value of the user adjustable range. For example, a potentiometer with an adjustable range from 10 V to 20 V can, for example, have a delivery setting 133 of 15 V.

The first output 141 is directly controlled by the variable control mechanism 130 and the second output 142 is controlled indirectly by the variable control mechanism 130. The first output 141 and the second output 142 can therefore each supply an output value that is controlled by the variable control mechanism 130.

The second output 142, as shown in FIG. 2, is controlled by the control unit 120 to supply an output value such as an output voltage, an output current, an output luminous intensity, or an output light color. The output value of the second output 142 is calculated by the control unit 120. Calculating the output value at the control unit 120, in an embodiment, includes converting an adjusted value corresponding to the actual setting 134 with a first characteristic, for example, a voltage, to an output value with a second characteristic, for example, an output voltage, an output current, an output luminous intensity, and an output light color. In another embodiment, calculating the output value at the control unit 120 additionally or alternatively includes multiplying the adjusted value by a certain constant.

As shown in FIG. 2, the EEPROM 111 stores a marker 112 and a trim setting 113. The trim setting 113 is an actual setting 134 of the conversion element 131 in a delivery state of the appliance 100. In an embodiment, the trim setting 113 is stored in advance by the manufacturer. The marker 112 is a code word indicating whether the appliance 100 is in the delivery state or not. A first code word TRUE, which can be a flag, a marker, or any storable information such as at least one bit, indicates that the appliance 100 is in a delivery state. As described in the processes below, the first code word TRUE is changed to a second code word FALSE. The second code word can be also a flag, a marker, or any storable information such as at least one bit. The second code word, which differs from the first code word by at least one bit, indicates that the appliance 100 is not in the delivery state. A person skilled in the art knows that changing the code word can comprise clearing a flag, overwriting the code word, replacing an index pointing to the code word, or the like. The information of the appliance 100 status can be stored and retrieved efficiently using the code words and, for example, the control unit 120 can determine the status of the appliance 100 by verifying only the code word.

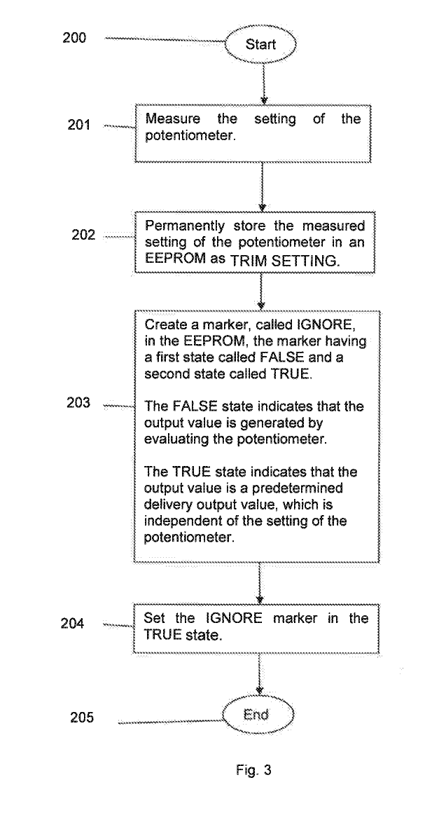

A sequence for storing the trim setting 113 in the memory unit 110 is shown in FIG. 3. The sequence starts at step 200 and is performed before the appliance 100 is delivered to a user.

In step 201, an actual setting 134, also referred to as the adjusted value, of the variable control mechanism 130 is sensed and processed by the control unit 120. The actual setting 134 is a value indicating the actual position of the variable control mechanism 130; an actual position of the user adjusting element 132 is converted by the conversion element 131 to form the actual setting 134. In an embodiment, the actual setting 134 is a voltage value of the potentiometer.

In step 202, the measured actual setting 134 is stored permanently as the trim setting 113 in the EEPROM 111. Additionally or alternatively, the actual setting 134 is stored as the trim setting 113 elsewhere in the memory unit 110. In an embodiment, a storing unit of the control unit 120 stores the trim setting 113 in the memory unit 110 and/or the EEPROM 111. In the shown embodiment, the control unit 120 stores the trim setting 113 in the EEPROM 111.

In step 203, the marker 112 is created in the EEPROM 111 or elsewhere in the memory unit 110. In an embodiment, the marker 112 is called IGNORE and the marker 112 has a first state called FALSE and a second state called TRUE. The FALSE state indicates that the output value at the second output 142 of the appliance 100 is generated by evaluating the variable control mechanism 130 via the control unit 120. In an embodiment, the adjusted value at the conversion element 131 is sensed and evaluated for generating the output value at the second output 142. The TRUE state indicates that the output value at the second output 142 is a predetermined delivery output value, which is independent of the variable control mechanism 130. In an embodiment, a creation unit of the control unit 120 creates the marker 112 in the memory unit 110 and/or the EEPROM 111. In another embodiment, the control unit 120 creates the marker in the memory unit 110.

In step 204, the control unit 120 sets the marker 112 in the memory unit 110 and/or the EEPROM 111 as the IGNORE marker in the TRUE state. In another embodiment, a setting unit of the control unit 120 sets the marker 112 in the memory unit 110 and/or the EEPROM 111 in the TRUE state.

In step 205, the process ends and the appliance 100 is in a delivery state.

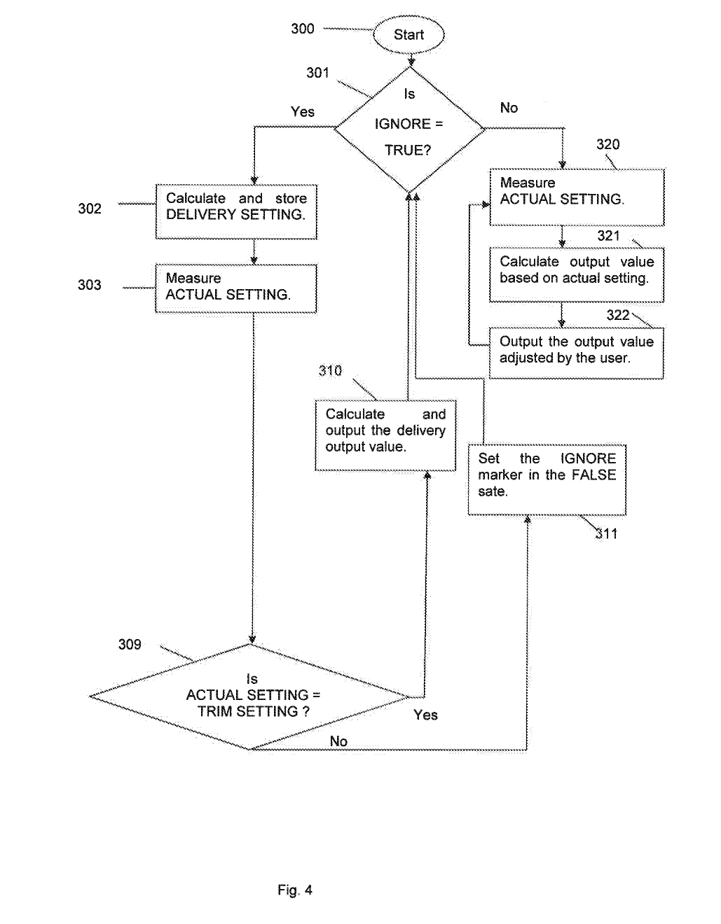

A sequence for operating the appliance 100 is shown in FIG. 4. The appliance 100 is either in a delivery state or in a different state. The sequence starts at step 300 by switching on the appliance 100 at an on/off switch. The sequence is executed by the control unit 120 and, in an embodiment, is executed by the processing unit 121.

In step 301, the marker 112 stored in the memory unit 110 is verified. If it is verified that the marker 112 IGNORE is in the status TRUE, the sequence proceeds with step 302.

A delivery setting 133 is calculated in step 302. The delivery setting 133, also referred to a predetermined setting, is based on predetermined values of the conversion element 131. Predetermined values of the conversion element 131 are, for example, the minimum and maximum value of the adjustable range of the conversion element 131. The delivery setting can, for example, be stored in the memory unit 110 or can be calculated by the control unit 120.

In step 303, an actual setting 134 of the variable control mechanism 130 is sensed in a similar way as described with reference to process step 201.

In step 309, the trim setting 113 is set in relation with the actual setting 134. The trim setting 113 is retrieved from the memory unit 110. The trim setting 113 has been stored in the memory unit 110 in advance according to the process described with reference to FIG. 2. The trim setting 113 is compared with the actual setting 134. If the trim setting 113 is equal to the actual setting 134, the process continues with process step 310. If the trim setting 113 is not equal to the actual setting 134, the process continues with process step 311. In other embodiments, it is not necessary that the trim setting 113 be equal to the actual setting 134; equal can be substituted with similar, less than, greater than, or the like. For example, it might be determined that the actual setting 134 is not within a trim region, the trim region ranging from the trim setting 113 plus or minus a predetermined value from the trim setting 113.

If it is determined in process step 309 that the actual setting 134 equals the trim setting 113, the sequence proceeds with process step 310. The delivery output value is output at the second output 142 in step 310. The delivery output value is a predetermined value that can be stored in the memory unit 110. Process step 310 can additionally comprise calculating the delivery output value by the control unit 120. The delivery output value can be calculated based on predetermined values of the conversion element 131; predetermined values of the conversion element 131 are, for example, the minimum and maximum value of the adjustable range of the conversion element 131.

If it is determined in process step 309 that the actual setting 134 is not equal to the trim setting 113, the sequence proceeds with process step 311. The IGNORE marker 112 is set in the FALSE state in step 311. The marker 113 is, for example, a code word stored in the memory unit 110 that is changed by the control unit 120 as described above. In an embodiment, after changing the code word of the marker 112, the second code word FALSE is permanently stored in the memory unit 110. The change is one-directional and irreversible. The first code word can only be changed if the first code word is stored and, in an embodiment, the first code word is overwritten. Once the first code has been changed for the first time it is not changed again. Consequently, one code word is sufficient for indicating whether the appliance 100 is in the delivery state

After process step 310 or process step 311, the sequence returns to process step 301. Starting with process step 301, the process steps 302, 303, 309, 310, and 311 build a delivery sequence for verifying and operating the appliance 110 in a delivery state. For a person skilled in the art, it is clear that process step 310 can be also executed after process step 301 and before process step 309 in this delivery sequence. The delivery sequence is operated until it is determined that the appliance 100 is not in the delivery state. If the appliance 100 is not in the delivery state, the marker 112 is changed in process step 311.

If it is verified in step 301 that the marker 112 IGNORE is in the status FALSE, the sequence proceeds with step 320. An actual setting 134 of the variable control mechanism 130 is sensed in step 320 in a similar way as described with reference to process step 201 or process step 303.

An output value is calculated in process step 321 based on the actual setting 134 sensing in step 320.

The output value calculated in process step 321 is output at the second output 142 in process step 322, and the sequence then returns to process step 320.

Process steps 320, 321, and 322 build an operation sequence for operating the appliance 100 when the appliance 100 is not in the delivery state. In this operation state, the appliance 100 outputs an output value adjusted by the user at the variable control mechanism 130.

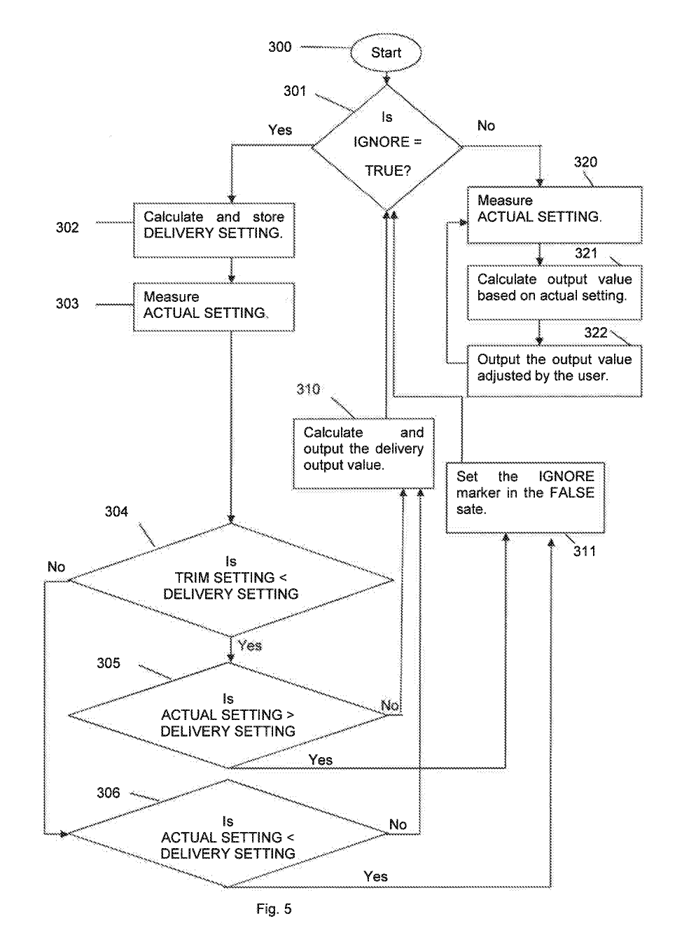

Another embodiment of a process of operating the appliance 100 is shown in FIG. 5. The sequence shown in FIG. 5 is mostly the same as the sequence shown in FIG. 4, except process step 309 is replaced by the process steps 304, 305, and 306. In the following, the process steps 304, 305, and 306 are explained in detail, while for the other process steps reference is made to the description of FIG. 4.

In step 304, the trim setting 113 is compared with the delivery setting 133. Each of the process steps 305 and 306 comprises comparing the actual setting 134 with the delivery setting 133. If in process step 304 it is determined that the trim setting 113 is less than the delivery setting 133, and in process step 305 it is determined that the actual setting 134 is not greater than the delivery setting 133, then the process proceeds with process step 310. The process also proceeds with process step 310 in the case that in process step 304 is determined that the trim setting 113 is not less than the delivery setting 133 and in process step 306 is determined that the actual setting 134 is not less than the delivery setting 133. Alternatively, the process proceeds with process step 311.

The process steps 304, 305, and 306 enable the appliance 100 to output the delivery output value until a user manually adjusts the variable control mechanism 130 according to a predetermined procedure.

The predetermined procedure will be explained by way of an example. The conversion element 131 is a potentiometer having a minimum value of 10 V and a maximum value of 20 V. The delivery setting 133 relates, for example, to a potentiometer value of 15 V.

In a first example, the trim setting 113 relates to a potentiometer value of 10 V; a potentiometer is at a left stop. The user turns the user adjusting element 132 to the right and increases the value of the actual setting 134. Until the actual setting 134 is greater than the predetermined delivery setting, the appliance 100 is in the delivery state and outputs the predetermined delivery output value.

In a second example, the trim setting 113 relates to a potentiometer value of 20 V; potentiometer is at a right stop. The user turns the user adjusting element 132 to the left and decreases the value of the actual setting 134. Until the actual setting 134 is less than the predetermined delivery setting, the appliance 100 is in the delivery state and outputs the predetermined delivery output value.

The appliance 100 can be manufactured using a potentiometer with a right stop or left stop. The code word of the marker 112 is not changed until the variable control mechanism 130 is adjusted by the user and an adjusted value of the variable control mechanism 130 fulfills a predetermined condition.

The appliance 100 is initialized in the delivery state using the processes described above. The control unit 120 automatically determines whether the appliance 100 is in a delivery state. The manufacturing process of the appliance 100 is simplified, the appliance 100 provides a more precise output value, and the appliance 100 can be assembled irrespective of the tolerances of the electrical components, for instance the tolerances of the potentiometer used to assemble the variable control mechanism 130.

What is claimed is:

1. A method for initializing an appliance in a delivery state, comprising:
providing a control unit connected to a memory unit and a variable control mechanism, the variable control mechanism is adjustable by a user to control an output value of the appliance;
storing a first code word in the memory unit, a predetermined delivery output value of the appliance is associated with the first code word; and
changing the first code word to a second code word using the control unit when the variable control mechanism is adjusted by the user.

2. The method of claim 1, wherein the variable control mechanism controls the appliance to output the output value adjusted by the user if the first code word is changed to the second code word.

3. The method of claim 2, further comprising the steps of:
sensing an adjusted value adjusted at the variable control mechanism using the control unit; and
calculating the output value at the control unit using the adjusted value.

4. The method of claim 1, wherein the control unit controls the appliance to output the predetermined delivery output value until the first code word is changed.

5. The method of claim 1, further comprising the steps of:
sensing an adjusted value corresponding to an actual setting adjusted at the variable control mechanism using the control unit; and
changing the first code word to the second code word when the actual setting fulfills a predetermined condition.

6. The method of claim 5, wherein the control unit changes the first code word to the second code word when a relationship between the actual setting and a trim setting fulfills the predetermined condition, the trim setting is a setting of the variable control mechanism in the delivery state.

7. The method of claim 6, wherein the trim setting and the actual setting are each compared with a delivery setting of the variable control mechanism.

8. The method of claim 1, wherein changing the first code word to the second code word is irreversible.

9. The method of claim 8, wherein the control unit overwrites the first code word with the second code word.

10. The method of claim 1, wherein the output value of the appliance is at least one of an output voltage, an output current, an output luminous intensity, and an output light color.

11. An appliance, comprising:
a variable control mechanism that is adjustable by a user to control an output value of the appliance;
a memory unit storing a first code word associated with a predetermined delivery output value of the appliance; and
a control unit connected to the variable control mechanism and the memory unit, the control unit changing the first code word to a second code word when the variable control mechanism is adjusted by the user.

12. The appliance of claim 11, wherein the memory unit is an electrically erasable programmable read-only memory.

13. The appliance of claim 11, wherein the variable control mechanism includes a user adjusting element that is adjustable by the user and a conversion element, the conversion element is adapted to convert an actual setting adjusted at the user adjusting element to an adjusted value sensed by the control unit.

14. The appliance of claim 13, wherein the conversion element is a potentiometer.

15. The appliance of claim 11, wherein the control unit includes a microprocessor.
